(19) United States
(12) Patent Application Publication
(10) Pub. No.: US 2004/0119181 A1
(43) Pub. Date: Jun. 24, 2004

(54) Method for controlling coalescence of particles forming a porous structure for example a bone implant

(76) Inventors: Michel Descamps, Wallers (FR); Pierre Hardouin, Le Touquet (FR); Jianxi Lu, Berck (FR); Francine Monchau, Famars (FR)

Correspondence Address: HARRISON & EGBERT, 412 MAIN STREET, 7TH FLOOR, HOUSTON, TX, 77002, US

(21) Appl. No.: 10/473,953

(22) PCT Filed: Apr. 4, 2002
(86) PCT No.: PCT/FR02/01183

(30) Foreign Application Priority Data
Apr. 5, 2001 (FR) 01/04658

(51) Int. Cl. B29C 33/38

(52) U.S. Cl. 264/40.1; 264/117; 264/219; 264/317; 425/150; 425/149; 425/406

(57) ABSTRACT

The invention concerns a method for controlling coalescence of particles forming a structure subjected to a treatment designed to establish crosslinking between said particles. The method consists in recording at least a physical quantity, whereof the evolution is continuously measurable and whereto the particle crosslinking is correlated, and in stopping the treatment when said physical quantity reaches a value corresponding the desired coalescence. The invention is characterized in that it consists in measuring as said physical quantity the shrinking of said structure. The invention also concerns a method and a device for making a structure of mutually crosslinked particles using said control method and a method for obtaining a product with interconnected pores, in particular for bone substitution, using such a structure.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a method for controlling the coalescence of particles, a method and a device for manufacturing an edifice of bridged particles, implementing such a control method as well as a process for obtaining a product with interconnected pores, notably intended for bone substitution, using the edifice obtained according to the former manufacturing process.

Although intended more particularly to the manufacture of a bone implant, said realization method could also be used for manufacturing any type of porous products.

### BACKGROUND OF THE INVENTION

Currently, in the field of bone substitution, it is known to use implants with interconnected pores.

Their manufacture is performed as follows:

realization of an edifice of bridged particles thanks to a coalescence treatment to form with the particles of said edifice, a skeleton occupying the location of the pores of the implant that is requested,

filling the interstices present between the particles of the edifice with the material of the implant, and

elimination of the skeleton.

Still, the porosity of the implants obtained is not always satisfactory. Indeed, said porosity is solely determined by the treatment time used during the coalescence of the particles of the skeleton and the other control operations, if any, are carried out after completion of manufacture, on samples.

The object of the invention is to provide a method for controlling the coalescence of particles which remedies the shortcomings mentioned above and ensures greater reliability.

It is another object of the invention to provide a method for controlling the coalescence of particles that is non-destructive.

It is another object of the invention to provide a method for controlling the coalescence of particles that is performed on-line.

Other objects and advantages will appear in the following description given by way of example and without being limited thereto.

### BRIEF SUMMARY OF THE INVENTION

The invention relates first of all to a method for controlling the coalescence of particles forming an edifice subjected to a treatment intended to cause the bridging of said particles together, a process wherein at least one physical quantity is considered, whereof the evolution can be measured continuously, and the treatment is stopped when said physical quantity has reached a given value corresponding to the coalescence requested, characterized in that the shrinkage of said edifice is measured as a physical quantity.

The invention also relates to a method for manufacturing an edifice of bridged particles wherein said particles are stacked according to the shape requested for said edifice, said particles are subjected to a coalescence treatment and, during said treatment, the coalescence of the particles is controlled according to the former process.

The invention also relates to a device for manufacturing an edifice of particles comprising a mould, enabling to stack up said particles and to undergo coalescence of said particles, characterised in that said mould is fitted with means for measuring the shrinkage of the stack of particles, with a view to controlling their coalescence during treatment.

The invention relates finally to a method for realising a product with interconnected pores, notably intended for bone substitution, wherein:

an edifice of bridged particles is prepared, according to the manufacturing method defined above to constitute with the particles of said edifice a skeleton occupying the location of the pores of the product that is requested, whereby said particles show interstices between them,

said interstices are filled with a material intended to constitute said product, and

said skeleton is eliminated.

### DETAILED DESCRIPTION OF THE INVENTION

The invention will be understood better when reading the following description which illustrates certain embodiments.

The invention relates first of all to a method for controlling the coalescence of the particles forming an edifice subject to a treatment intended to bridge said particles together.

It may be particles of any shapes or of predetermined shapes, such as spherical or tubular shapes. The size of these particles will be adjusted according to the application desired. When manufacturing edifices intended for the realization of bone implants, their sizes may vary from 50 microns to 5 millimeters, if not more. In a same edifice, said particles could have the same sizes or not.

To control their coalescence, at least one physical quantity is considered, whereof the evolution can be measured continuously, and the treatment is stopped when said physical quantity has reached a given value corresponding to the coalescence requested.

According to the invention, the shrinkage of said edifice is measured as a physical quantity. Indeed, it has been noticed that such shrinkage is correlated directly to the bridging between the particles. More accurately, it is proportional to said bridging and does not depend on oxtomal conditions, which facilitates the formation of causal relations and the exploitation of the measurements.

Consequently, the bridging phenomenon can be controlled better and edifices can be obtained, whereof the interconnections between particles may be greater than half the sizes thereof.

Said shrinkage may be measured, for example, by monitoring the evolution in thickness of the edifice along a given direction.

The invention also relates to a method for manufacturing an edifice of bridged particles wherein said particles are stacked according to the shape requested for said edifice, said particles are subjected to a coalescence treatment and, during said treatment, the coalescence of the particles is controlled according to the former process and this, for better control of the bridging phenomena thanks to the physical quantity observed, i.e. the shrinkage of the edifice.

According to a particular embodiment, the coalescence of the particles will be obtained by chemical dilution. More accurately, said edifice could be impregnated in a solvent, then said solvent could be eliminated partially after a certain time while leaving a thin film of solvent on said particles so that said film is located at the contact point between the particles and bridges them. It may be a solvent, notably a ketonic solvent, enabling slow and gradual dissolution of said particles.

It can be noted that with this mode of treatment, the formation of the interconnections between particles will be influenced, notably, by the chemical aggressiveness of the solvent with respect to the particles, by the dipping time of the edifice in the solvent, by the quantities of solvents used or still the room temperature. Thus, for instance, for particles of same granulometry, the lower the room temperature, the longer the time necessary to obtain a given level of interconnection.

Conversely, as already said, for particles of same granulometry, a given shrinkage corresponds to a given level of interconnection, regardless of the external conditions. It is therefore not necessary to reproduce, when bridging a given edifice, the conditions wherein the causal relation between the shrinkage of the edifice and the coalescence of the particles will have been established for edifices of such type.

In the case of a treatment by chemical dilution, the particles used may be, for example products of polystyrene, polyethylene, polyamide, polymethylmetacrylate type or others.

Still according to this mode of treatment, the bridging phenomenon will be stopped by elimination the residual solvent, for example by drying the edifice.

The invention still relates to a device for manufacturing an edifice of bridged particles, notably for implementing the former method.

Said device comprises a mould, enabling to stack up said particles and to undergo a coalescence treatment thereof.

In the case of a treatment by chemical dilution, the mould will be composed, for instance, of a material that is chemically inert with respect to the solvents used.

According to the invention, said mould is fitted with means for measuring the shrinkage of said particles. It enables to control their coalescence during their treatment.

Said measuring means are composed, for instance,

of a piston intended to slide in the mould along a given direction, in contact with said particles,

of a sensor for detecting the displacements of said piston.

Consequently, the shrinkage of the edifice is measured by measuring its variation in thickness along said direction. The sensor used may be of mechanical, electric, optoelectronic type or others.

More accurately, said mould may comprise a lid closing a moulding cavity capable of accommodating said particles, said lid making up the piston of said measuring means. The sensor of said means will be composed, notably, of a rod slaved to said lid, and of means for detecting the movements of said rod.

The invention relates still to a method for realizing a product with interconnected pores, wherein:

an edifice of bridged particles thanks to a coalescence treatment is prepared according to the manufacturing method defined above, to form with the particles of said edifice a skeleton occupying the location of the pores of the product that is requested, said particles exhibiting interstices between them,

said interstices are filled with a material intended to constitute said product, and

said skeleton is eliminated.

Consequently, thanks to the coalescence control of the particles of the edifice, the porosity of the implant may be controlled, more reliably than before, in a non-destructive fashion, and without any correction step. It is thus possible to provide products with an architecture wherein the pores are controlled as well from a uniformity viewpoint as from a dimensional or morphology viewpoint.

In the case of the manufacture of bone implants, it is possible to fill in the interstices present between the particles forming the edifice with a suspension composed of thinly divided mineral or metallic powder in an aqueous or organic solvent including various compounds such as dispersants, binders, anti-foaming agents, wetting agents and/or others.

The mineral or metallic powders will be chosen, notably, among the biocompatible compounds such as bio-glasses, compounds based on pure or doped calcium phosphates (hydroxyapatite, tricalcic phosphate), pure or doped calcium carbonates, pure or doped aluminum or zirconium oxides, titanium, pure or doped stainless steels and/or others.

Said suspension is then left to dry before eliminating the skeleton which may be realized by thermal treatment.

After elimination of the skeleton, densification or sintering operations may also be contemplated for the residual matter whereof the temperatures will be adapted to the materials used. These operations may be carried out in open air or under controlled atmospheres.

Naturally, other embodiments, understandable to the man of the art, could have been contemplated without departing from the framework of the invention.

We claim:

1. A method for controlling the coalescence of particles forming an edifice subjected to a treatment intended to cause the bridging of said particles together, a process wherein at least one physical quantity is considered, whereof the evolution can be measured continuously and to which the bridging of the particles in correlated, and the treatment is stopped when said physical quantity has reached a given value corresponding to the coalescence requested, characterized in that the shrinkage of said edifice is measured as a physical quantity.

2. A control method according to claim 1, wherein the shrinkage may be measured by monitoring the evolution in thickness of the edifice along a given direction.

3. A method of manufacture of an edifice of particles, bridged together, wherein said particles are stacked according to the shape requested for said edifice, said particles are subjected to a coalescence treatment and, during said treatment, the coalescence of the particles is controlled according to the processes of claims 1 or 2.

4. A method of manufacture of an edifice of particles according to claim 3, wherein the coalescence of the particles is obtained by chemical dilution, thanks to a solvent with which said edifice is impregnated, before partial elimination of said solvent in order to leave a thin film of solvent on said particles.

5. A method of manufacture of an edifice of particles according to claim 4, wherein the treatment is caused to stop par elimination of the residual solvent by drying.

6. A device for manufacturing an edifice of particles comprising a mould, enabling to stack up said particles and to undergo coalescence of said particles, characterized in that said mould is fitted with means for measuring the shrinkage of the stack of particles, with a view to controlling their coalescence during treatment.

7. A device according to claim 6, wherein said measuring means are composed:
of a piston intended to slide in the mould along a given direction, in contact with said particles,
of a sensor for detecting the displacements of said piston.

8. A device according to claim 7, wherein:
the mould comprises a lid closing a moulding cavity capable of accommodating said particles, said lid making up the piston of said measuring means,
said sensor is composed of a rod slaved to said lid, and of means for detecting the movements of said rod.

9. A method for obtaining a product with interconnected pores, notably intended for bone substitution. wherein:
an edifice of bridged particles thanks to a coalescence treatment is prepared according to the manufacturing method defined in any of the claims 3 to 5, to form with the particles of said edifice a skeleton occupying the location of the pores of the product that Is requested, said particles exhibiting interstices between them,
said interstices are filled with a material intended to constitute said product,
said skeleton is eliminated.
